(19) United States
(12) Patent Application Publication
(10) Pub. No.: US 2024/0001554 A1
(43) Pub. Date: Jan. 4, 2024

(54) SYSTEMS AND METHODS FOR DISTANCE BASED ROBOTIC TIMEOUTS

(71) Applicant: Brain Corporation, San Diego, CA (US)

(72) Inventor: Micah Richert, San Diego, CA (US)

(21) Appl. No.: 18/215,326

(22) Filed: Jun. 28, 2023

Related U.S. Application Data
(60) Provisional application No. 63/356,715, filed on Jun. 29, 2022.

(51) Int. Cl. B25J 9/16

(52) U.S. Cl. CPC B25J 9/1666; B25J 9/1676

(57) ABSTRACT

Systems and methods for distance-based robotic timeouts are disclosed herein. According to at least one non-limiting exemplary embodiment, a robot experiencing a high-level controller timeout may continue to execute its previously given motion command for a threshold timeout distance without hindering safety, while avoiding unnecessary stops or jitters.

### CROSS REFERENCE TO RELATED APPLICATIONS

This application claims the benefit of U.S. Provisional application No. 63/356,715 filed on Jun. 29, 2022, the contents of which are incorporated by reference herein.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods related to distance based robotic timeouts.

### SUMMARY

The foregoing needs are satisfied by the present disclosure, which provides for, inter alia, systems and methods distance based robotic timeouts.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally be referred to autonomous vehicle or object that travels a route, executes a task, or otherwise moves automatically upon executing or processing computer readable instructions.

According to at least one non-limiting exemplary embodiment, a robot is disclosed. The robot comprises a non-transitory computer readable storage medium comprising a plurality of computer readable instructions stored thereon; and at least one controller configured execute the computer readable instructions to: embody a high-level controller configured to issue motion commands under soft real time constraints to the low level controller; and embody a low-level controller configured to issue actuator commands in response to the motion commands under strict real time constraints; and maintain a prior motion command if a timeout of the high-level controller is detected until the robot has traveled a threshold timeout distance.

Embodiments of the robot include the following, alone or in any combination. The low-level controller is further configured to detect for emergency stop conditions following the timeout and stop the robot if the emergency stop conditions are met.

The motion commands configure the robot to follow a route.

The low-level controller is further configured to stop movement of the robot if a new motion command is not issued before the robot reaches the threshold timeout distance.

The high-level controller is further configured to issue a new motion command to the low level controller after the timeout; determine a displacement of the robot after the timeout caused by maintaining the prior motion command; and based on the new motion command and the displacement, calculate a third motion command in accordance with the route.

The displacement of the robot after the timeout is measured via at least one of an encoder or gyroscope.

The low-level controller is further configured to detect for emergency stop conditions following the new motion command.

The soft real time constraints comprise real time responses to an input with no maximum response time; and strict real time constraints comprise real time responses to an input with a limited maximum response time.

According to at least one non-limiting exemplary embodiment, a method for routing a robot is provided. The method comprises issuing motion commands under soft real time constraints by a high-level controller; issuing actuator commands, by a low-level controller, in response to the motion commands under strict real time constraints; and maintaining a prior motion command, by the low-level controller, if a timeout of the high-level controller is detected until the robot has traveled a threshold timeout distance.

Embodiments of the method include the following, alone or in any combination.

The motion commands configure the robot to follow a route.

The method may further comprise the low-level controller detecting for emergency stop conditions following the timeout and stopping the robot if the emergency stop conditions are met.

The method may further comprise the low-level controller stopping movement of the robot if a new motion command is not issued before the robot reaches the threshold timeout distance.

The method may further comprise the high-level controller issuing a new motion command after the timeout; determining a displacement of the robot after the timeout caused by maintaining the prior motion command; and based on the new motion command and the displacement, calculating a third motion command in accordance with the route.

The method may further comprise the low-level controller detecting for emergency stop conditions following issuing of the new motion command.

According to at least one non-limiting exemplary embodiment, a non-transitory computer readable storage medium comprising a plurality of computer readable instructions stored thereon is disclosed. The computer readable instructions, when executed by a processor comprising a high level controller and a low level controller, configure the processor to cause the high-level controller configured to issue motion commands under soft real time constraints; and cause the low-level controller to issue actuator commands in response to the motion commands under strict real time constraints; and maintain a prior motion command if a timeout of the high-level controller is detected until the robot has traveled a threshold timeout distance.

Embodiments of the non-transitory computer readable storage medium include the following, alone or in any combination.

The motion commands configure the robot to follow a route.

The computer readable instructions further configure the processor to execute the computer readable instructions to cause the low-level controller to detect for emergency stop conditions following the timeout and stop the robot if the emergency stop conditions are met.

The computer readable instructions further configure the processor to execute the computer readable instructions to cause the low-level controller to stop movement of the robot if a new motion command is not issued before the robot reaches the threshold timeout distance.

The computer readable instructions further configure the processor to execute the computer readable instructions to cause the high-level controller to issue a new motion command after the timeout; determine a displacement of the robot after the timeout caused by maintaining the prior motion command; and based on the new motion command and the displacement, calculate a third motion command in accordance with the route.

The computer readable instructions further configure the processor to execute the computer readable instructions to cause the low-level controller to detect for emergency stop conditions following the issuance of the new motion command.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2 is a functional block diagram of a high-level controller and a low-level controller in accordance with some embodiments of this disclosure.

FIG. 3 is a route in accordance with some embodiments of this disclosure.

FIG. 4 is a process flow diagram illustrating a method for a controller of a robot to navigate the robot while considering high-level controller timeouts, according to an exemplary embodiment.

FIG. 5 is a robot navigating along a route and experiencing a high-level controller timeout, according to an exemplary embodiment.

FIG. 6 is a route and corresponding timing diagram illustrating, given a high-level controller timeout, motions commands executed in response to the timeout, according to an exemplary embodiment.

FIG. 7 is a process flow diagram illustrating a method for a low-level controller to operate a robot while handling a high-level controller timeout and safety constraints, according to an exemplary embodiment.

All Figures disclosed herein are © Copyright 2023 Brain Corporation. All rights reserved.

### DETAILED DESCRIPTION

Generally, robots are complex systems with multiple sensors collecting inputs, multiple levels of processing or abstraction layers to process the sensor inputs, and various timing requirements both to ensure functionality and safety, with safety being a primary concern. In robotic systems, it is common for timing delays to occur for various reasons. For example, a sensor malfunction may cause interruption in transmission of data, thereby causing a time delay which propagates through the system that processes the sensor data. Often these timing delays are on the order of a few milliseconds, however on occasion delays can be tens of milliseconds to seconds which may cause timeouts. Timeouts occur when the robotic system should have received a new command, or other update (e.g., a sensor reading), but does not within a stated period (e.g., the period of a control cycle). A common approach to handling timing delays may comprise, if a timeout is experienced, stopping the robot and if the timeout continues to persist, hailing for human assistance. This maximizes safety but hinders task performance by requiring the robot to stop and await a new command during every timeout, which may occur frequently for robotic systems with rapid control cycles. Continuously stopping for timing delays may yield jittery and inefficient motion. In some respects, jittery motion of a robot may confuse nearby humans as to the desired actions of the robot which may in turn further hinder task performance and safety. Accordingly, there is a need in the art for systems and methods for handling timeouts and time delays in a robotic system which does not hinder operational performance or safety of established methods.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for distance based robotic timeouts. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAY® vehicles, etc.), trailer movers, vehicles, and the like. Robots may also include any autonomous and/or semi-autonomous machine for transporting items, people, animals, cargo, freight, objects, luggage, and/or anything desirable from one location to another.

Various references to timing are made herein. Time durations include a start time and a different, later end time, wherein time is typically measured by a number of central processing unit (“CPU”) clock cycles which have occurred, and the clock cycle period is a fixed temporal duration. Time delays, as used herein, refer to a duration between an instance in time when a signal is expected and when the signal is received. If the duration between the expected and received time instances exceeds a threshold duration, a timeout occurs. Temporal durations in electronic systems are typically measured via timestamps for receipt/transmission of signals, such as storing a value in a register or reading the value, wherein timestamps include a CPU cycle number for a given signal. Typically, the timestamp for a given operation (e.g., read, write, compare, etc.) includes a number of CPU cycles performed since startup of the CPU which can be used to measure time durations in terms of, e.g., seconds.

A control cycle, as used herein, corresponds to a number of seconds or CPU cycles between generations of consecutive motor commands. Control cycles may dictate timing requirements for a high level controller to receive sensory data, process the sensory data, and plan actions of a robot accordingly, wherein the controller should produce its necessary outputs prior to the period of the control cycle expiring to ensure smooth movement.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processor such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C #, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) reduce hindrance of task performance caused by timing delays; (ii) allow robots to recover from many timeouts without human assistance or jittery motion; and (iii) ensure safety of operating the robotic system given a timeout scenario. Other advantages are readily discernable by one having ordinary skill in the art given the contents of the present disclosure.

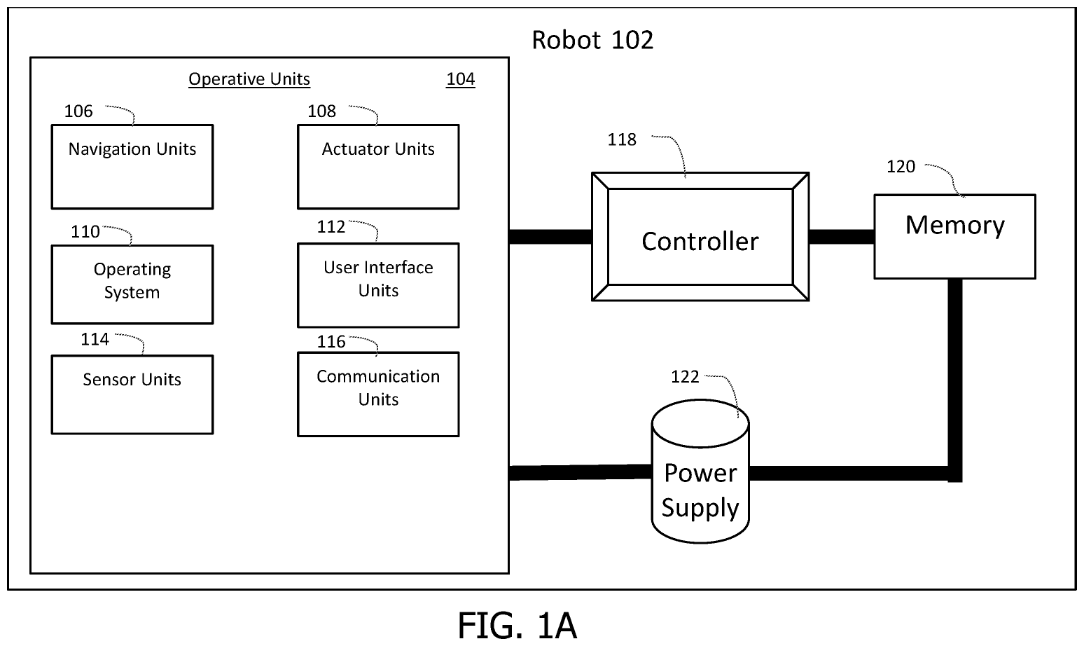

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices or processors (e.g., microprocessors) and other peripherals. As previously mentioned and used herein, processor, microprocessor, and/or digital processor may include any type of digital processor such as, without limitation, digital signal processors (“DSPs”), reduced instruction set computers (“RISC”), complex instruction set computers (“CISC”), microprocessors, gate arrays (e.g., field programmable gate arrays (“FPGAs”)), programmable logic device (“PLDs”), reconfigurable computer fabrics (“RCFs”), array processors, secure microprocessors and application-specific integrated circuits (“ASICs”). Peripherals may include hardware accelerators configured to perform a specific function using hardware elements such as, without limitation, encryption/description hardware, algebraic processors (e.g., tensor processing units, quadradic problem solvers, multipliers, etc.), data compressors, encoders, arithmetic logic units (“ALU”), and the like. Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be internal to or on board robot 102 and/or may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors. In some embodiments, a single controller (e.g., controller 118) may serve as the various controllers and/or processors described. In other embodiments different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously, or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find its position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; and/or repose cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processor, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processor 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132, which stores computer code or computer readable instructions in order for the processor 130 to execute the specialized algorithms. As illustrated in FIG. 1B, memory 132 may comprise some, none, different, or all features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

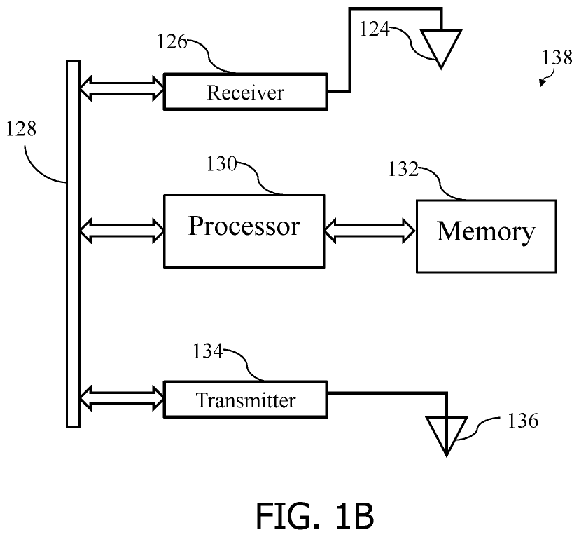

One of ordinary skill in the art would appreciate that the architecture illustrated in FIG. 1B may also illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processors 138 thereof executing computer readable instructions and, in some instances, the use of any hardware peripherals known within the art. Controller 118 may be illustrative of various processors 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processors 138 for performing high level tasks (e.g., planning a route to avoid obstacles) and processors 138 for performing low-level tasks (e.g., producing actuator signals in accordance with the route).

FIG. 2 is a functional block diagram of computer readable instructions executed by a controller 118 of a robot 102 that cause the robot 102 to navigate a route, according to an exemplary embodiment. The two functional blocks shown comprise a high level controller (“HLC”) 202 and a low level controller (“LLC”) 204. The HLC 202 is configured to issue high-level commands including, but not limited to, interpreting sensory data to construct computer readable maps, path planning, translating a known route to individual motor commands needed to execute the route, and other processes which are in soft real time. As used herein, soft real time includes real-time operations that do not include maximum timing requirements and may be variable in duration. Conversely, as used herein, strict real time refers to processes that include a maximum timing requirement. For instance, during navigation of a route, determining which path (e.g., left or right) to take around an obstacle may not have a maximum timing requirement, wherein the robot 102 may take as long as it likes (ignoring inefficient task performance) to calculate its choice of path without being a risk to safety. Conversely, a strict real time condition may include the LLC 204 stopping the robot 102 upon determining if an object is below a threshold distance from the robot 102, wherein not having a maximum response time could pose a risk of colliding with the object if the robot 102 does not respond quickly. These distinctions between soft and strict real time functions and their relationship with timing of commands will be discussed and illustrated further below. To illustrate further, examples of soft real time processes may include, but are not limited to, map construction, path optimizations, performance metric calculations, and/or some task performances (e.g., clean an area). Some examples of strict real time processes may include, without limitation, joyride detections (e.g., stopping the robot upon detecting an unauthorized human is seated thereon), potential object collisions, and/or high-risk hardware failures (e.g., excessive heat, battery malfunctions, etc.).

The HLC 202 receives signals 206 from sensor units 114. These sensor units 114 may include any or all of the sensor units described in FIG. 1A above. Signals 206 may also comprise data retrieved from memory 120 and/or communications units 116 such as, e.g., prior maps of a given route, tasks to perform, a goal/target location to navigate to, and the like. Using data from signals 206, the HLC 202 may issue signals 210, 212. Signals 210 comprise at least motor commands, wherein the motor commands are determined via the HLC 202 determining an efficient path for the robot 102 and high-level commands to be issued to the actuators 108. Such commands may include, for example, upon a robot 102 reaching a certain location, moving at (v, θ) until it reaches a next location. The precise, e.g., pulse-width modulated signals sent to the actuator units 108 to achieve the (v, θ) state will be determined by the LLC 204 and communicated via signals 214. In other words, the HLC 202 determines the path for the robot 102 in signal 210 which is then translated by the LLC 204 into electrical currents communicated to the actuators via signal 214.

Signals 212 may comprise outputs of various calculations performed by the HLC 202. For instance, updates to a computer readable map based on new sensor data from signal 206, updates to a current route (e.g., if an obstacle is present), task performance metrics, localization data, and/or other operational characteristics of the robot 102 which may be stored in memory 120 and do not require immediate (i.e., strict real time) use.

The LLC 204 may be configured to receive signals 208 comprising data from sensor units 114 of a particular type. As discussed above, the LLC 204 operates in strict real time thereby imposing maximum processing/response times of the LLC 204 for any input 208. For instance, the LLC 204 may be configured to implement safety stops if an object is detected within a threshold minimum distance. Such safety stop may be handled via a single if/then statement when given, e.g., serial planar LiDAR data, a bump/collision/tactile sensor, etc. Conversely, a two-dimensional depth image provides N×M pixels of data, each comprising a depth (and color in some instances) value, thereby requiring the entire image be processed to determine if an object is close to the robot 102. Unlike serial/continuous measurements from a planar LiDAR, gyroscope, wheel encoder, and the like, sensors such as depth cameras output discrete packets of data which may require additional time to process, and thus may pose a safety risk for the LLC 204 to issue stops in response to detected objects quickly. Accordingly, such large packets of data may be handled by the HLC 202 under soft real time requirements. Other examples of input 208 may include emergency stop buttons which immediately cease robotic operation and joyride protections (e.g., seat or weight sensors) which immediately cease robotic operation upon detecting an unauthorized passenger.

One skilled in the art may appreciate that the specific sensor data processed by the HLC 202 and LLC 204 may depend on various parameters such as processing speed of controller 118, the size of data packets from non-serialized sensors (e.g., depth cameras), the complexity of the high level commands of the HLC 202, and operational safety concerns of the robot 102 within its environment. For instance, it may be preferable for a robot 102 operating in a crowded place with many dynamic objects (e.g., humans) to limit the computations performed by the LLC 204 to ensure, if needed, stops occur before collisions.

Timing delays, as used herein, refer to a time difference between an expected time at which a controller (e.g., controller 118, HLC 202, and/or LLC 204) is expected to receive an input and when it receives the input. For instance, the LLC 204 may be coupled to a spinning LiDAR sensor with a sampling frequency of 1 sample/millisecond, wherein the LLC 204 expects a new measurement every millisecond. A timing delay would occur if, between any two samples, the time difference is greater than 1 millisecond. A timeout, as used herein, occurs when a timing delay exceeds a threshold duration. For instance, following the same spinning LiDAR example, if the LLC 204 does not receive a new measurement from the sensor within 1 second from a prior measurement, a timeout may occur if the threshold is 1 second. Such timeouts may be implemented as a safety precaution to stop a robot 102 in an event a sensor malfunctions or is disconnected entirely, wherein the controllers do not receive updated information of the environment, thereby making navigation unsafe.

It is common within the art to simply use timeouts with various thresholds depending on the sensor/controller as a general safety measure. However, these timeouts often cause interruptions in operations by the robot 102. If instead the robot was allowed to wait for an updated sample as opposed to timing out, it could recover from time delays and continue operating as normal. Accordingly, the systems and methods disclosed herein enable robots 102 to lessen an impact on performance caused by timeouts/time delays while maintaining safety in navigation.

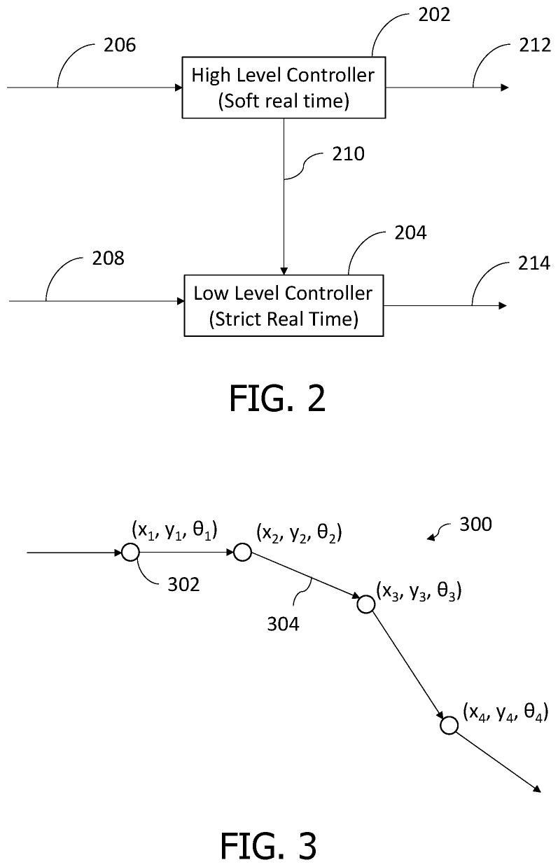

FIG. 3 illustrates a route 300 and components thereof, in accordance with the exemplary embodiments of this disclosure. The route 300 comprises a plurality of nodes 302, where each node may denote a state for the robot 102 to reach. The state for each node 302 may include, for two-dimensional space such as a bird's eye view, (x, y, θ) location and orientation. For three-dimensional space, such as aquatic robots or airborne drones, the states may further include (x, y, z, yaw, pitch, roll). Additionally, based on the functions of the robot 102, certain states may be added to denote the tasks to be performed by the robot 102. For instance, if the robot 102 is an item transport robot, additional state parameters which denote, e.g., “drop off object” and “pick up object” may be utilized.

Each node 302 is connected to previous and subsequent nodes 302 via a link 304. Links 304 may denote a shortest path from one node 302 to the next node 302. Typically, the nodes 302 are spaced close enough such that the links 304, which comprise straight-line approximations, are sufficiently small to enable smooth movement. Other methods of non-linear interpolation may be utilized; however, such methods may be computationally taxing to calculate.

Upon arriving at a given node 302, the HLC 202 may calculate a path to the next node 302 based on its current tasks and data from sensor units 114, e.g., being processed into a computer readable map, and provide a motion command 210 to the LLC 204. Typically, the calculated path may follow approximately the path of the links 304. On occasion, the HLC 202 may detect objects obstructing the path, wherein the HLC 202 may calculate a new path around the objects via manipulating the states of the nodes 302, adding new nodes 302, and/or deleting nodes 302 and interpolating between them. Under typical circumstance, the sensor units 114 of the robot 102 should detect any obstructions prior to the robot 102 navigating to a node 302 which is obstructed, providing the controller 118 with time to adjust future route nodes 302 prior to reaching them if an obstacle is sensed.

If the HLC 202 does not provide a new motion command 210 to the LLC 204 before the robot 102 reaches a subsequent node 302 in the route 300, the HLC 202 may be considered “timed out” because failing to provide a new motion command 210 by this time would cause the robot 102 to jitter and stop frequently at each node 302 as it waits for a new command 210 to execute to reach the next node 302. The time delay between when the HLC 202 calculates/issues the next motion command and/or the LLC 204 executes the motion command from the prior motion command has exceeded a threshold time, the threshold time being equal to the time needed to travel between nodes 302. Although not materially impactful on safety, the HLC 202 timing out may negatively impact task performance, thus it is preferable that any time delays from executing a first motion command to executing a subsequent motion command is less than the time needed to travel between sequential nodes 302.

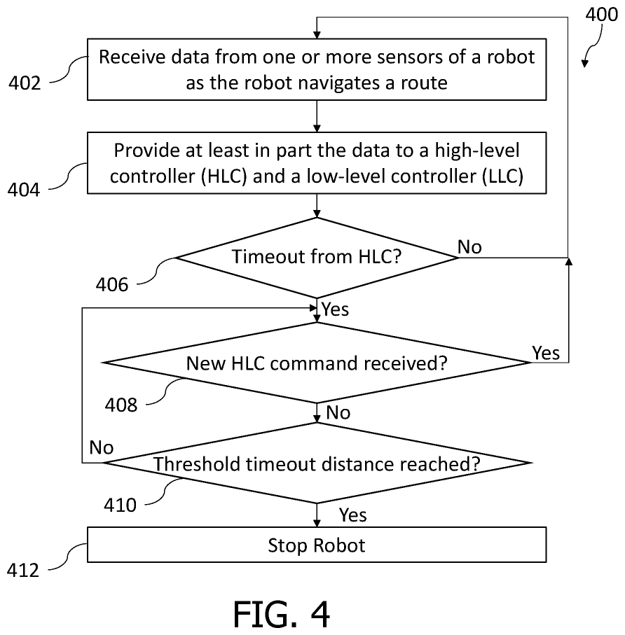

FIG. 4 is a process flow diagram illustrating a method 400 for a controller 118 of a robot 102 to navigate a route, according to a non-limiting exemplary embodiment. Steps of method 400 are effectuated via the controller 118 executing computer readable instructions from memory 120.

Block 402 includes the controller 118 receiving data from one or more sensors units 114 of the robot 102 as the robot 102 navigates a route. The robot 102 may be autonomously navigating or navigating under user guided or assisted control. As the robot 102 navigates, data from sensor units 114 may be collected, processed, and stored to construct, among other things, a map and path for the robot 102 to follow.

Block 404 includes the controller 118 embodying, via executing computer readable instructions, a HLC 202 and an LLC 204 and providing them with, at least in part, data received in block 402. As discussed above, the HLC 202 operates under soft real time constraints, wherein real-time responses are provided for given inputs 206 without strict timing requirements due to safety concerns. The HLC 202 may, for instance, aggregate point cloud data from sensors 114 into a computer readable map for navigating; plot a route to follow on the computer readable map; track its location on the computer readable map; determine high-level tasks (e.g., navigate to location, retrieve object, etc.); and track performance metrics. The LLC 204 is configured to issue low-level commands in response to sensory data 208 and HLC 202 commands 210. For instance, without limitation, the LLC 204 may process serialized data (e.g., from a spinning LiDAR), translate high level commands 210 into precise signals 214 to actuator units 108, and/or perform immediate response safety operations (e.g., stopping upon an “emergency-stop” signal). The primary use of the LLC 204 is to rapidly process data under strict real time constraints imposed by safety requirements for operating the robot 102. For instance, if an object is close to the robot 102 the robot 102 must stop within a strict maximum time period, whereas transferring data from a depth camera to a computer readable map may not require such rapid response and therefore larger variance in processing time is permissible.

Block 406 includes the controller 118 determining if a timeout has occurred from the HLC 202. Specifically, the LLC 204 expects to receive a new motor command 210 from the HLC 202 within a set time window beginning when the prior motor command was received/executed by the LLC 204. It is appreciated that the clock rate of the controller 118 remains constant, however the number of clock cycles required to calculate a new motion command may vary for each iteration and could, potentially, exceed a threshold duration. The new motor command may include a specified velocity, acceleration, angle, and/or other state parameters for the robot 102 to undertake to reach a subsequent node 302 in the route, wherein the LLC 204 translates the commands into specific actuator signals 214 to achieve such state. The timeout from the HLC 202 may occur for a variety of reasons. For instance, the HLC 202 may be executing complex computational processes triggered by, e.g., specific environmental/task scenarios, which add additional time delay between any two issued motor commands. Other reasons for time delays may include, for instance, delays in signals 206 (e.g., from a sensor malfunction), delays in processing of signals 206, the HLC 202 being preoccupied by one or more subroutines, and misfunctioning hardware/software. The time duration needed for a timeout to occur in block 406 may be on the order of tens of milliseconds to seconds, based on the configured frequency of the motor command outputs 210 from the HLC 202. The configured frequency may be a predetermined duration set by a manufacturer of a robot 102 based on, for instance but not limited to, the separation between route nodes 302, processing speed of the controller 118, frequency of sensor units 114, amount of sensory data to be processed, avoiding jittering (as discussed in FIG. 3 above), and other intrinsic parameters of the robot 102.

Upon the controller 118, specifically the LLC 204, receiving a new motor command within a threshold duration corresponding to a timeout from the HLC 202, the LLC 204 executes the motor command, and the process 400 returns to block 402.

Upon the controller 118 determining a timeout occurred from the HLC 202, the controller 118 moves to block 408.

Block 408 includes the controller 118 determining if a new HLC 202 command 210 is received by the LLC 204. If a new HLC 202 command is received, the LLC 204 executes the command and the process 400 returns to block 402. If no new HLC 202 command is received, the controller 118 moves to block 410. It is important to note that the HLC 202 is still timed out, however if at any point in blocks 408-410 the HLC 202 issues a new command, the system can be considered recovered from its timeout and continue navigating. However, after the timeout is reached (block 408) the robot 102 can avoid jittering by continuing to follow its current motion command for additional time via executing blocks 408-410 and navigate safely.

Block 410 includes the controller 118 determining if a threshold timeout distance has been reached. The threshold timeout distance comprises a distance in space in which the robot 102 may continue executing a given HLC 202 motor command, despite not receiving a new HLC 202 motor command after a given timeout duration (block 406) in which the new HLC 202 command should have been received.

By way of an illustrative non-limiting example, consider a robot 102 with a control cycle time of 3 seconds. That is, the time between time the HLC 202 is required to provide new motor commands is every 3 seconds. The HLC 202 must, beginning at a time of issuing a first motor command, receive any new sensory data, process the sensory data, update its computer readable maps, update paths if needed, perform diagnostics, and determine a second motor command all within 3 seconds from the time the first motor command was issued. The HLC 202 may issue a motor command causing the robot 102 to move at (v₀, θ₀) and, while calculating (v₁, θ₁) for the next control cycle, take more than 3 seconds and therefore time out. For instance, a certain subroutine triggered by a task or environmental context may cause the excessive time delay in issuing (v₁, θ₁) due to added computations performed. As another example, a malfunctioning sensor failing to provide new data may cause the time delay in issuing the new command to exceed a timeout duration. Although the HLC 202 has timed out, the LLC 204 may continue to execute the motion command (v₀, θ₀) safely within a spatial region around where the motion command (v₀, θ₀) was initially issued. It is appreciated that robots often plan their paths far in advance than the current motion command. Following the current example, in executing (v₀, θ₀) the HLC 202 may have already planned out twenty (i.e., (v₀, θ₀) through (v₂₀, θ₂₀)) motion commands ahead of time which account for obstacles proximate to the robot 102, thereby allowing the robot 102 to continue executing its current motion command safely. Further, each control cycle is typically tens of milliseconds to few seconds, and the distance between nodes is on the order of inches to a few feet, wherein the threshold timeout distance is not sufficiently large, despite deviating from a planned route, to cause safety concerns.

While the HLC 202 is timed out, navigating via the LLC 204 continuing to execute the prior command may continue to be safe. Additional anti-collision safety checks may still be performed by the LLC 204 if the HLC 202 is timed out and not issuing updated commands. For instance, the LLC 204 can check if a sensor detects an object within a threshold distance, as this may indicate possible collision without needing to map the object in 2D or 3D space (as done by the HLC 202). Emergency stop sensors can also be received and processed by the LLC 204 quickly. Distance traveled by the robot 102 may be measured accurately via encoders and/or gyroscopes, as these instruments are typically serial outputs which can be rapidly and easily (i.e., with low computing bandwidth) processed by the LLC 204. Further, encoders (e.g., of wheels) are typically analog signals yielding accurate measurement of changes in distance on local scales. If the sensory inputs 208 to the LLC 204 time out, malfunction, or are not received while the HLC 202 is timed out, the robot 102 should stop immediately due to safety concerns. Detecting objects being too close to a robot 102 from other sensor modalities, for instance depth cameras, may require the controller to process packets of data (e.g., individual depth images) of varying size as the packets are received, which may cause variance in the output frequency of, e.g., motor commands based on the packets. Accordingly, such sensor modalities with large variance in processing time are preferably handled by the HLC 202 under soft real time requirements.

The LLC 204 may integrate the distance traveled as measured by the encoders and/or gyroscope of the robot 102 to determine its displacement from a location wherein the previous HLC 202 command 210 was received and compare the displacement with the threshold timeout distance.

If the LLC 204 determines the threshold timeout distance has not been reached, the process 400 returns to block 408 and continues to navigate given the previous HLC 202 command until either (i) a new HLC 202 command 210 is received, or (ii) the threshold timeout distance is reached.

If the LLC 204 determines the threshold timeout distance has been reached without a new HLC 202 command 210, the process 400 moves to block 412 to stop the robot 102. In some instances, human assistance may be hailed, or internal diagnostics processes may be executed to return the HLC 202 to issuing commands 210.

Advantageously, configuring stops of the robot 102 based on distance traveled after a timeout may cause the robot 102 to, in the event of an HLC 202 timeout, recover in many instances without needing to stop. Often timeouts from the HLC 202 are on the order of seconds, wherein the robot 102 traveling at its maximum speed may only travel a few feet. Timeouts causing stops may greatly impact robotic task performance, yielding jitters in the robot 102 motion on occasion. Further, based on the strict real time configuration of the LLC 204, safety is not impacted by this improvement as will be discussed further below.

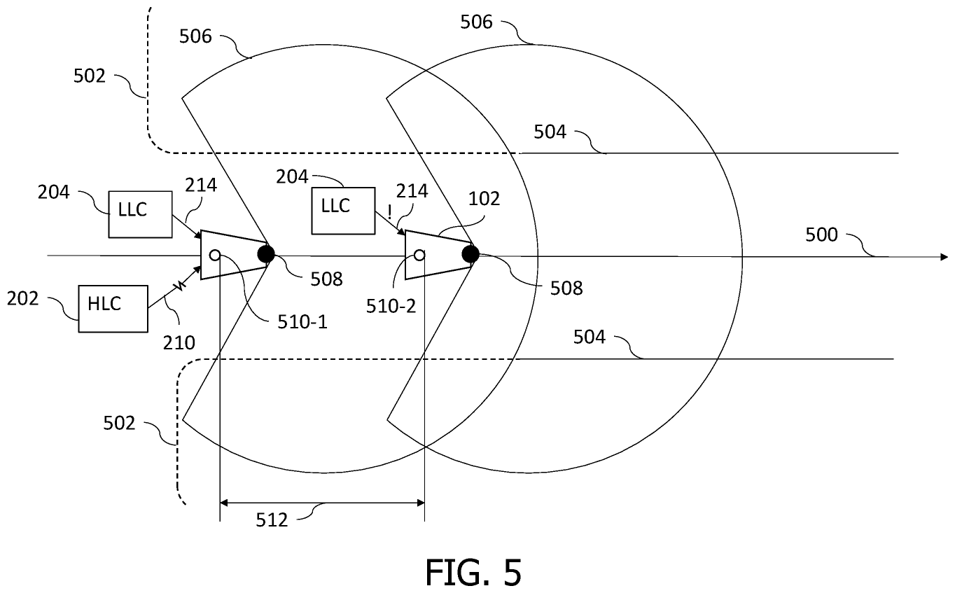

FIG. 5 is a top-down view illustrating a robot 102 performing method 400 to navigate along a route 500, according to an exemplary embodiment. The route 500 includes the robot 102 navigating between two objects bounded by points 502 and lines 504. While at position 510-1, one or more sensors 508 may collect measurements of the surrounding environment as shown by sensor field of view (“FOV”) 506. For instance, sensor 508 may include a LiDAR sensor, depth camera, or multiple sensors. Using data collected within the FOV 506, the HLC 202 may process the data to generate a computer readable map, wherein the nearby objects are represented by points 502. Points 502 may represent pixels, points of a point cloud, or areas which are occupied by an object, as determined by data from sensor(s) 508. Lines 504 are for illustrative clarity; however, it is appreciated that while at location 510-1 the robot 102 does not sense the portion of the nearby objects shown by lines 504, and accordingly does not map these portions. In other words, the dashed/dotted lines 502 are representative of points from, e.g., a LiDAR sensor or pixels on a map, whereas the solid lines 504 represent the actual environment which is shown for visual clarity. It is appreciated, however, that the robot 102 does not map the location of objects shown by lines 504.

Prior to reaching location 510-1, the HLC 202 may have issued a motor command 210 for the LLC 204 to execute. However, in the illustrated exemplary embodiment, upon reaching the location 510-1 the LLC 204 has not received a new motion command 210 from the HLC 202 within a timeout period (block 406). Despite not receiving an updated command from the HLC 202, as shown by points 502 and FOV 506, the robot 102 may have sufficient data to plan the route 500 such that the previous motor command 210 may still be valid for achieving the goal route. Stated another way, it is highly unlikely that, from the time the previous motion command 210 was issued, substantial change to the map would necessitate a change in the route 500, wherein continuing with the prior motion commands 210 will still approximately follow the route 500 without substantial deviation even if the computer readable map data is not fully updated. Additionally, if dynamic moving objects come into FOV 506 while the HLC 202 is timed out (i.e., while the computer readable map is not being updated), the LLC 204 may still be able to halt the robot 102 in case of emergency by e.g., sensing an object, dynamic or otherwise, being within a threshold distance without the requirement of the HLC 202 mapping the object and planning a route in response thereto. Such emergency stop may be performed without substantial regard to the direction of travel of the dynamic object, which may require further tracking/processing of the sensor 508 data over time which typically is handled by the HLC 202 under soft real time constraints. Further, such emergency stop may be performed without requiring localization of the objects detected close to the robot 102 on a computer readable map (as represented by line 504 not being mapped while the HLC 202 is timed out), wherein the stop can be issued upon any object being close enough to the robot 102 and/or its sensor units 114.

The robot 102 may continue to navigate given the prior motion command 210 until either (i) the HLC 202 issues a new command, or (ii) the robot 102 reaches a threshold timeout distance 512 from the location where the HLC 202 timed out. As shown, the robot 102 navigates to location 510-2 and does not receive a new motion command 210 from HLC 202 and accordingly stops. The LLC 204 issues the command 214 commanding the robot 102 to stop immediately, as indicated by an exclamation point. Upon stopping, the robot 102 may: (i) stop and wait for the HLC 202 to issue a new command 210 (e.g., for a longer time duration), (ii) perform internal diagnostics such as rebooting or halting one or more subroutines, and/or (iii) hail for human assistance if all else fails.

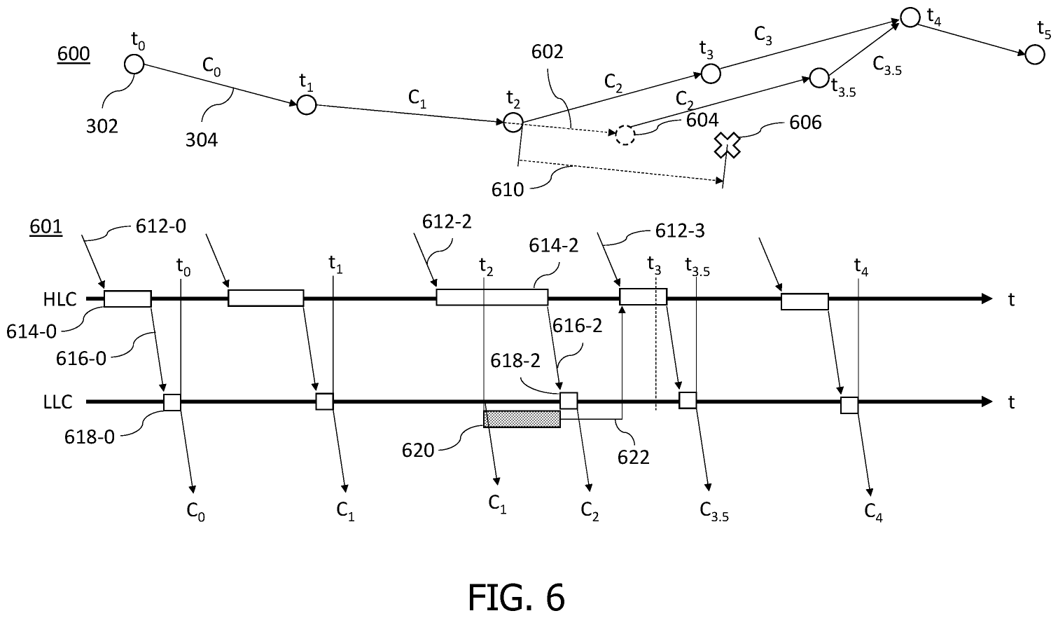

FIG. 6 illustrates a segment of a route 600 comprising several nodes 302 and timing diagram 601 corresponding to the route 600 in accordance with method 400 described above, according to an exemplary embodiment. The time at which a robot 102 navigating the segment reaches the n^{th} node 302 is denoted as tₙ, wherein n is an integer representing the node 302 number. Commands Cₙ represent motion commands issued by a HLC 202 to a LLC 204 for moving between an n^{th} node 302 to an n+1^{th} node 302. The commands Cₙ are determined via the HLC 202 processing data from various sensor units 114 to, e.g., produce maps, plan paths, reach goals, and/or perform tasks under soft real time requirements.

Shown below the route is a timing diagram 601 with two timing tracks representing processes performed by both the HLC 202 and LLC 204 to effectuate movement of the robot 102 along the path. Inputs 612 may correspond to data from sensor units 114, state information of the robot 102 (e.g., location, velocity, etc.), computer readable maps from memory, and any other data required to perform the high-level functions of the robot 102 such as path planning, task performance, and the like. During each control cycle (e.g., periods between tₙ and tₙ₊₁) the HLC 202 may perform various high level tasks using inputs 612 received from sensors 114 and/or from memory 120 including, at least in part, motion commands 616 to be sent to the LLC 204. The duration of the control cycles is a fixed duration determined based on characteristics of the robot 102, its controller 118, sensor units 114, and capabilities. As shown, the operations 614 performed by the HLC 202 vary in duration. In some instances, the data processing required to determine future motion commands 210 may be minimal, such as when a robot 102 is navigating in a straight-line path in a featureless environment. In other instances, the data processing may be more complex, such as producing a curving path around dynamic moving objects in a feature rich environment. In some instances, the featureless and feature rich environments may be different locations within a building or enclosure. The variance in duration is permissible with safety concerns of the robot 102 since the HLC 202 does not directly cause motion of the robot 102 without first issuing motion commands 210 to the LLC 204. Ideally, the HLC 202 should produce a new motion command 616 prior to the robot 102 reaching a subsequent state point at which the LLC 204 will execute the motion command 616 as outputs 620 to avoid jitter. The LLC 204 is configured to translate the motion commands 616-n into actuator or motor commands Cₙ via processes 618-n to effectuate the specified motion, in addition to other safety functions which operate under strict timing requirements (e.g., emergency stops). Processes 618 performed by the LLC 204 are typically short in duration and may be effectuated via, e.g., look up tables, ASICs, and other devices to translate state commands to actuator signals and handle simple threshold logic safety conditions using, preferably, serialized data inputs (e.g., as opposed to packets of data).

In some instances, however, the HLC 202 may experience delays (e.g., in inputs 612 or otherwise caused by extensive data processing, bugs, errors, etc.) or other issues that cause the HLC 202 to time out, or in other words produce a new motion command 616 after the control cycle has completed. For instance, at node 1 and time t₁ the HLC 202 has produced a motion command 616-1 for the LLC 204 to determine a motor command C₁ for execution at node 1. During execution of the determined motor command C₁, the HLC 202 may begin calculating the motion command 616-2 C₂ for the next node 2. However, as shown by the timing diagram, the process 614-2 is delayed and the HLC 202 does not produce a new command 616-2 until after time t₂ (i.e., after the control cycle window has expired and is therefore timed out). In accordance with method 400 above, motor command C₁ will persist as shown by the LLC 204 re-issuing or maintaining the command C₁ at time t₂.

Upon issuing or maintaining the current motor command C₁ during a HLC 202 timeout, the LLC 204 performs a process 620 to track the distance traveled by the robot 102 after the HLC 202 timeout at time t₂. Such process 620 may include integrating data from a gyroscope over time or determining displacement via encoders coupled to means of locomotion of the robot 102 (e.g., treads, wheels, etc.). Process 620 is illustrated separately from processes 618 to illustrate the two processes/subroutines are executed contemporaneously by different sub-controllers. Sometime after t₂, the HLC 202 timeout may end when the HLC 202 issues a motion command 616-2 to the LLC 204, wherein the LLC 204 begins issuing motor commands C₂ to actuator units 108 based on the motion command 616-2. If, however, the LLC 204 measures that the robot 102 has moved a threshold distance from the start of the timeout, t₂, and the HLC 202 does not transmit an updated motion command 616-2, then the robot 102 stops.

With reference to the above route 600, after time t₂ wherein the HLC 202 is timed out and command C₁ is maintained, the robot 102 may have been displaced from the initial route as shown by segment 602. The robot 102 may reach a location 604 when motion command 616-2 is determined by the HLC 202 due to the persistence of the motion command C₁. Additionally, location 606 shows where the robot 102 would have reached following motor command C₁ after time t₂, had the HLC 202 not recovered prior to the robot 102 traveling the threshold timeout distance 610 in accordance with method 400 above. Location 606 is where LLC 204 would have determined to stop the entire system because it had reached its threshold timeout distance wherein continuing to move without updated HLC 202 commands, maps, sensor measurements, and plans would be potentially dangerous.

According to at least one non-limiting exemplary embodiment, the length of the threshold distance 610 may be dependent on the number of dynamic moving objects present near the robot 102 which would be a parameter tracked by the HLC 202 based on sensory and map data and communicated to the LLC 204. Typically, timeouts are on the order of a few seconds, wherein it is unlikely a substantial number of new dynamic objects would be within collision range of the robot 102 prior to reaching threshold distance 610 and/or the HLC 202 recovering. Accordingly, even if the HLC 202 is currently timed out, the previous determination of the nearby dynamic objects would still be a valid estimate. Similarly, distance to the nearest dynamic object could also be utilized to modulate the threshold distance 610, wherein more dynamic objects being closer to the robot 102 would lessen the threshold distance 610, and vice versa, for the next control cycle if the HLC 202 times out.

It is appreciated that the process 614-2 began and is executed using data from input 612-2 and earlier, wherein the robot 102 is calculating the motion command C₂ using old data, which may not account for the displacement 602 from the route caused by the timeout. Since the HLC 202 is timed out after t₂, displacement 602 data from the LLC 204 subroutine 620 may not have been processed by the HLC 202 prior to the HLC 202 issuing motion command 616-2. Thus, the command C₂ may still be issued once the process 614-2 completes regardless of displacement 602. In some embodiments, following the issuance of command C₂, feedback 622 may be provided to the subsequent HLC process 614-3 to ensure the motion command C_{3.5} accounts for the displacement 602 from the original trajectory 600. Further, output from sensors may inform HLC 202 that the robot is not at the node 302 expected at t₂. As shown, rather than executing the originally planned motion command C₃ at time t₃, the robot 102 executes a modified motion command C_{3.5} at time t_{3.5} (where t_{3.5}-t₃ is the time spent navigating segment 602) which corrects the trajectory back toward the original path. Although the correction to the original path is shown in only one control cycle, in some instances the robot 102 may navigate to a plurality of nodes to correct back to the original path. For example, a plurality of nodes in the revised path may be used to avoid an object in the revised path or provide a more efficient or smoothed path back to the route. In some cases, the HLC 202 may determine that a more efficient path to follow along route 600 and may skip node four (4) and proceed toward node five (5) at t₅ if, for example, the distance from node three point five (3.5) to node five (5) is shorter than the combined distance from node three point five (3.5) to node four (4) to node five (5). Advantageously, the motion of the robot 102 is preserved while minimizing erroneous path following to only one or very few nodes following the timeout. In other embodiments, the HLC 202 may be configured to continuously localize the robot 102, wherein such displacement 602 may be accounted for via the HLC 202 and considered when determining the future motion command C_{3.5}. Advantageously, divergence from the original route is kept to a minimum whilst operation and motion of the robot 102 is left uninhibited. Additionally, in conjunction with method 700 described next, this performance enhancement does not impact safety.

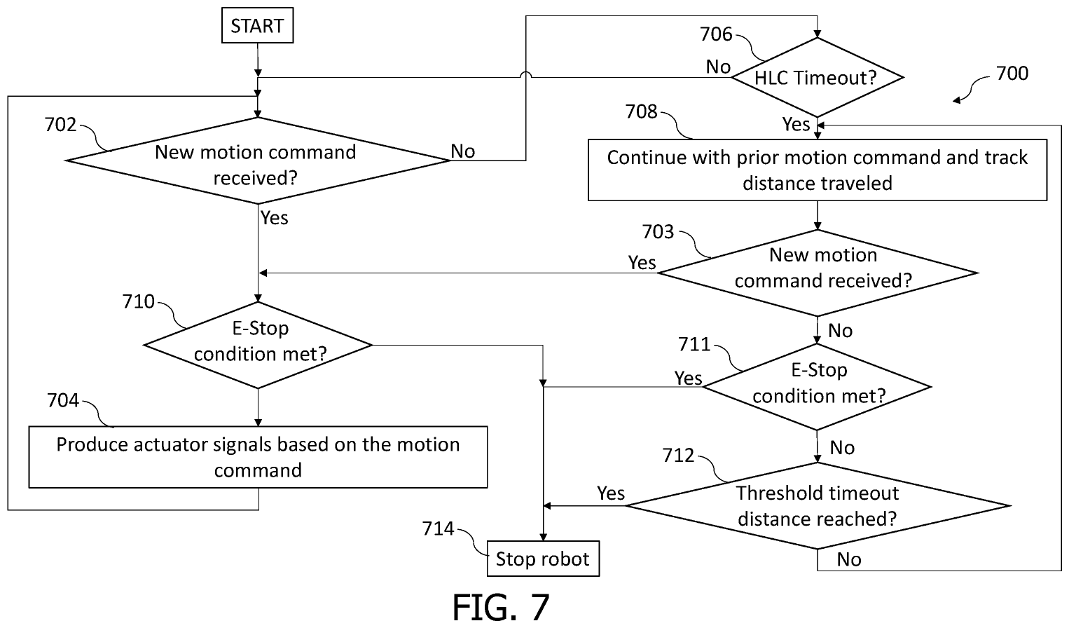

While the above processes 614, 618 are performed by the HLC 202 and LLC 204, respectively, to navigate the robot 102 along the route, the LLC 204 may continuously check for emergency stop (“E-stop”) conditions. Such E-stop conditions comprise situations wherein the robot 102 must immediately stop within a strict time period to avoid a collision with an object and/or other critical failures. For instance, the LLC 204 may check for objects being within a threshold distance of the robot 102, wherein the LLC 204 may stop or slow the robot 102 as to avoid potential collision. Such process may be performed absent a computer readable map and utilize threshold logic processes which typically have low variance in processing duration, and thus can be performed under strict real time requirements. Failure conditions may include, for instance, one or more sensors used for the aforementioned threshold logic processes becoming disconnected or failing to provide new data in time (i.e., timeout of a safety critical sensor), or one or more critical safety sensors indicating an emergency stop condition (e.g., a seat sensor detecting presence of a person joy-riding on the robot 102 or other emergency stop condition). The sensor inputs 208, described in FIG. 2 above, of which the LLC 204 may utilize in detecting E-stop conditions is not shown in FIG. 7 for clarity.

FIG. 7 is a process flow diagram illustrating a method 700 for operating an LLC 204 in accordance with safety constraints, according to an exemplary embodiment. The LLC 204 may be illustrative of the controller 118 of a robot 102 executing computer readable instructions from a memory 120. In some instances, the LLC 204 may additionally comprise hardware elements such as look-up tables, ASIC's, and other firmware components used to translate high level motion commands into actuator unit 108 signals.

Block 702 includes the LLC 204 determining if a new motion command 210 is received from an HLC 202. If a new motion command is received, the LLC 204 moves to block 710. In some embodiments, the new motion command may comprise a stop or shut down command which exits the LLC 204 from process 700 and powers down the robot 102.

Blocks 710 and 711 (discussed below) include the LLC 204 checking for E-stop conditions. E-stop conditions, as discussed above, correspond to any condition in which the robot 102 must stop or slow within a strict time requirement. Preferably, E-stop conditions should be able to be identified absent computer readable maps or extensive processing of senor data, either of which may cause a time delay which may not be permissible under strict real time requirements. E-stops may be triggered upon detecting an object within a threshold distance using, e.g., data from a spinning planar LiDAR or other range sensor with serial output. E-stops may also be triggered by specific sensors such as seat sensors to prevent joy-riding on the robot 102, bump sensors to detect contact with objects, and/or detection of critical sensor timeouts, disconnections, malfunction, or specific error messages therefrom. If an E-stop condition is met, the controller moves to block 714 to stop the robot 102. If no E-stop conditions are met, the controller 118 continues to block 704.

Block 704 includes the LLC 204 producing actuator unit 108 signals based on the motion command. Various embodiments of motion commands exist in the art with varying levels of abstraction from the signals communicated to actuator units 108. For instance, the motion command may simply specify a velocity and heading angle for the robot 102 to maintain, wherein the LLC 204 translates these parameters into signals to actuator units 108 (e.g., PWM). In some embodiments, time parameters may be considered, wherein the motion command may specify an acceleration with duration for the LLC 204 to translate into actuator signals.

In addition to motion, the command received from the HLC 202 may further specify task-specific state parameters. For instance, if robot 102 is a floor cleaner, the command may further indicate if the robot 102 is to clean (e.g., activate a scrubbing brush) or not clean. As another example for item delivery/transport robots 102, the HLC 202 command may indicate where and when to pick up or drop off a payload. That is, the motion commands are not intended to be limiting to mere displacement of the robot 102 and may also refer to other task-specific actuators.

Upon executing the motion command, the LLC 204 returns to block 702 to await the subsequent motion command to be executed.

Block 706 includes the LLC 204 determining if the HLC 202 has timed out based on not receiving a new motion command within a threshold time period (as shown by the cycle between blocks 702 and 706). If the HLC 202 has timed out, the LLC 204 moves to block 708, otherwise the LLC 204 returns to block 702.

Block 708 includes the LLC 204 continuing with a prior motion command and tracking distance traveled by the robot 102. As illustrated above in FIG. 6, the LLC 204 should continuously be executing motion commands to ensure smooth movement of the robot 102. The prior motion command corresponds to the motion command being executed when or just before the HLC 202 timeout (i.e., the last “yes” to block 702). In embodiments where the motion command includes an acceleration component, such component may be ignored or, in some embodiments, limited to a maximal velocity of the robot 102. That is, the robot 102 should not continue accelerating if it causes the robot 102 to exceed its maximum safe speed limits.

Following block 708, the LLC 204 checks again for a new motion command in block 703. If a new motion command is received, the LLC 204 returns to block 710 and on to 704 if no E-stop conditions are found and executes the new command. Otherwise, the LLC 204 continues to block 711.

Block 711 includes the LLC 204 checking for E-stop conditions. If an E-stop condition is met, the LLC 204 moves to block 714 to stop the robot 102. If no E-stop conditions are met, the LLC 204 moves to block 712.

Block 712 includes the LLC 204 determining if the robot 102 has traveled a threshold timeout distance since the HLC timeout began in block 706. The threshold timeout distance may be measured as a distance traveled by the robot 102 from the location in block 706, such as the arc-length of a curve if the prior motion command included a turn. In some embodiments, the threshold distance may be a displacement from the robot 102 location in block 706 invariant of the path taken to achieve such displacement. The magnitude of the threshold timeout distance may be based upon, for example, the momentum (i.e., size, weight, and speed) of the robot 102, the environment the robot 102 operates within (e.g., environments with many humans may desire a shorter threshold timeout distance), the separation between nodes 302 of the route, range and sampling frequency of sensor units 114, control cycle duration, and the processing speed of the controller 118 (i.e., average time duration of a HLC 202 timeout). If the robot 102 has traveled the threshold timeout distance without having received a new HLC 202 motion command, the LLC 204 moves to block 714 to stop the robot 102. Otherwise, if the threshold timeout distance has not been reached, the LLC 204 returns to block 708.

Block 714 includes the LLC 204 stopping the robot 102. In some embodiments, stopping the robot 102 may cause the LLC 204 to enter a wait state for a substantially longer period of time to await a new HLC 202 command 210. Since the robot 102 is stopped, the time spent waiting for the HLC 202 may be increased without impacting safety. In some instances, the HLC 202 may recover and issue a new motion command, wherein the process 700 begins again. In some instances, such as E-stop conditions being met or the HLC 202 failing to find a collision free path, the robot 102 may hail for human assistance.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term “includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A robot, comprising
a non-transitory computer readable storage medium comprising a plurality of computer readable instructions stored thereon; and
at least one controller configured execute the computer readable instructions to:
embody a high-level controller configured to issue motion commands under soft real time constraints to a low level controller; and
embody the low-level controller configured to
issue actuator commands in response to the motion commands under strict real time constraints; and
maintain a prior motion command if a timeout of the high-level controller is detected until the robot has traveled a threshold timeout distance.

2. The robot of claim 1, wherein the low-level controller is further configured to:
detect for emergency stop conditions following the timeout; and
stop the robot if the emergency stop conditions are met.

3. The robot of claim 1, wherein the motion commands configure the robot to follow a route.

4. The robot of claim 3, wherein the low-level controller is further configured to stop movement of the robot if a new motion command is not issued before the robot reaches the threshold timeout distance.

5. The robot of claim 3, wherein the high-level controller is further configured to:
issue a new motion command to the low level controller after the timeout;
determine a displacement of the robot after the timeout caused by maintaining the prior motion command; and
based on the new motion command and the displacement, calculate a third motion command in accordance with the route.

6. The robot of claim 4, wherein
the displacement of the robot after the timeout is measured via at least one of an encoder or gyroscope.

7. The robot of claim 4, wherein the low-level controller is further configured to:
detect for emergency stop conditions following the new motion command.

8. The robot of claim 1, wherein
soft real time constraints comprise real time responses to an input with no maximum response time; and
strict real time constraints comprise real time responses to an input with a limited maximum response time.

9. A method for routing a robot, comprising:
issuing motion commands under soft real time constraints by a high-level controller;
issuing actuator commands, by a low-level controller, in response to the motion commands under strict real time constraints; and
maintaining execution of a prior motion command, by the low-level controller, if a timeout of the high-level controller is detected until the robot has traveled a threshold timeout distance.

10. The method of claim 7, wherein the motion commands configure the robot to follow a route.

11. The method of claim 10, further comprising the low-level controller detecting for emergency stop conditions following the timeout.

12. The method of claim 10, further comprising the low-level controller stopping movement of the robot if a new motion command is not issued before the robot reaches the threshold timeout distance.

13. The method of claim 10, further comprising the high-level controller issuing a new motion command after the timeout;
determining a displacement of the robot after the timeout caused by maintaining the prior motion command; and
based on the new motion command and the displacement, calculating a third motion command in accordance with the route.

14. The method of claim 13, further comprising the low-level controller detecting for emergency stop conditions following issuing of the new motion command.

15. A non-transitory computer readable storage medium comprising a plurality of computer readable instructions stored thereon, that when executed by a processor comprising a high level controller and a low level controller, configure the processor to:
cause the high-level controller configured to issue motion commands under soft real time constraints; and
cause the low-level controller to issue actuator commands in response to the motion commands under strict real time constraints; and
maintain a prior motion command if a timeout of the high-level controller is detected until the robot has traveled a threshold timeout distance.

16. The non-transitory computer readable storage medium of claim 15, wherein the motion commands configure the robot to follow a route.

17. The non-transitory computer readable storage medium of claim 16, wherein the computer readable instructions further configure the processor to execute the computer readable instructions to cause the low-level controller to detect for emergency stop conditions following the timeout.

18. The non-transitory computer readable storage medium of claim 16, wherein the computer readable instructions further configure the processor to execute the computer readable instructions to cause the low-level controller to stop movement of the robot if a new motion command is not issued before the robot reaches the threshold timeout distance.

19. The non-transitory computer readable storage medium of claim 16, wherein the computer readable instructions further configure the processor to execute the computer readable instructions to cause the high-level controller to:
issue a new motion command after the timeout;
determine a displacement of the robot after the timeout caused by maintaining the prior motion command; and
based on the new motion command and the displacement, calculate a third motion command in accordance with the route.

20. The transitory computer readable storage medium of claim 16, wherein the computer readable instructions further configure the processor to execute the computer readable instructions to cause the low-level controller to detect for emergency stop conditions following the issuance of the new motion command.
